(19) United States
(12) Patent Application Publication
(10) Pub. No.: US 2026/0370180 A1
(43) Pub. Date: Nov. 19, 2026

(54) SOLAR MODULE DROP-IN MOUNT DESIGN

(71) Applicant: Nextpower LLC, Fremont, CA (US)

(72) Inventors: Yiwei Jiang, Hayward, CA (US); Madeleine Davis Kho, Oakland, CA (US); Craig Bradley Edward Wildman, Kensington, CA (US); Ryan Patel, Pleasanton, CA (US); Ricardo Delgado-Nanez, San Jose, CA (US); Ning Liu, Folsom, CA (US)

(21) Appl. No.: 19/671,687

(22) Filed: May 8, 2026

Related U.S. Application Data
(60) Provisional application No. 63/805,257, filed on May 13, 2025.
(60) Provisional application No. 63/845,552, filed on Jul. 17, 2025.

(51) Int. Cl. H02S 20/32; H02S 30/10

(52) U.S. Cl. CPC H02S 20/32; H02S 30/10

(57) ABSTRACT

An assembly includes a solar module frame and a module support rail that is configured to couple to the solar module frame. The solar module frame includes a coupling tab. The module support rail includes a torque tube interface surface, a wall extending away from the torque tube interface surface, and a locking member that is movable relative to the wall. The wall includes a locking slot adjacent to the locking member. When the coupling tab is received at the locking slot, the locking member is configured to move relative to the wall to engage the coupling tab to thereby restrict movement of the solar module frame relative to the module support rail.

### RELATED APPLICATIONS

This application claims the benefit of U.S. Provisional Patent Application No. 63/805,257, filed May 13, 2025, and also claims the benefit of U.S. Provisional Patent Application No. 63/845,552, filed Jul. 17, 2025, the entire contents of both of which is incorporated herein by reference.

### TECHNICAL FIELD

This disclosure relates generally to solar tracker systems, and more particularly to systems and methods of providing frames for solar modules within solar tracker systems designed for simplified installation.

### BACKGROUND

Solar cells and solar panels are most efficient in sunny conditions when oriented towards the sun at a certain angle. Many solar panel systems are designed in combination with solar trackers, which follow the sun's trajectory across the sky from east to west to maximize the electrical generation capabilities of the systems. The relatively low energy produced by a single solar cell requires the use of thousands of solar cells, arranged in an array, to generate energy in sufficient magnitude to be usable, for example as part of an energy grid. As a result, solar trackers have been developed that are quite large, spanning hundreds of feet in length and including hundreds of individual solar modules that are mechanically coupled to support structures.

A conventional solar tracking system includes a plurality of components assembled and installed on site in the field at the location where the solar tracking system is to operate. Typical solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Typical solar trackers require the use of at least four fasteners to secure the solar module to the rails. Thus furthers the manual labor required to install solar modules. Moreover, oftentimes solar tracking systems are installed in relatively remote locations and thus installation necessitates costs associated with bringing manual labor to the relatively remote site to execute manual installation over what can be a significant period of time. As such, current typical manual labor solar tracking system component installation can add significant cost to a solar tracking system application. The present disclosure seeks to address the shortcomings of prior tracker systems.

### SUMMARY

Embodiments disclosed herein can enable installation of a solar module frame at a solar tracker rail in a manner that provides structural stability between the rail and the frame, such as restricting or preventing relative movement between the rail and the frame, but yet can do so in a manner that can help to reduce components interconnections between components, reduce installation time, and reduce costs associated with installation a solar tracker system.

An assembly embodiment disclosed herein includes a solar module frame and a module support rail that is configured to couple to the solar module frame. The solar module frame includes a coupling tab. The module support rail includes a torque tube interface surface, a wall extending away from the torque tube interface surface, and a locking member that is movable relative to the wall. The wall includes a locking slot adjacent to the locking member. When the coupling tab is received at the locking slot, the locking member is configured to move relative to the wall to engage the coupling tab to thereby restrict movement of the solar module frame relative to the module support rail.

In a further embodiment of this assembly, when the coupling tab is received at the locking slot, the locking member is movable relative to the wall between an unlocked position, at which the locking member is spaced apart from the coupling tab and offset from the locking slot, and a locked position, at which the locking member engages the coupling tab and is aligned with the locking slot. In some examples, the locking slot is a first locking slot and the locking member is a first locking member, and the module support rail further includes a second locking slot at the wall and spaced apart along the wall from the first locking slot, where the module support rail further includes a second locking member that is movable relative to the wall and adjacent to the second locking slot. In some examples, the locking member includes a hook element that pivots between the unlocked position and the locked position. Also in some examples, the locking slot can extend along the wall in a first direction generally transverse to the torque tube interface surface and in a second direction generally parallel to the torque tube interface surface, with the extent of the locking slot in the first direction is greater than the extent of the locking slot in the second direction.

Another embodiment disclosed herein includes a solar tracker assembly. This solar tracker assembly embodiment includes a plurality of foundations arranged in a row, at least one support beam extending along the row, a plurality of solar module assemblies being coupled to and rotated by the at least one support beam, and a plurality of rails coupling the plurality of solar module assemblies to the at least one support beam. The at least one support beam defines a central longitudinal axis extending therethrough and is pivotally mounted to the plurality of foundations, with the pivotal mounting permitting the at least one support beam to rotate about an axis of rotation parallel to the row. The rotation of the plurality of solar modules orienting the modules about the axis of rotation, with the solar module assemblies each including a frame and a solar module supported by the frame, the frame having a protruding tab. The plurality of rails are distributed at different longitudinal locations along the central longitudinal axis, with each rail having a first upright wall and a second upright wall extending away from the at least one support beam and forming a channel therebetween. The first upright wall defines locking slots, with each locking slot sized to receive and interlock with one of the protruding tabs upon sliding within the slot, and each locking slot interlocked with one of the protruding tabs, with the interlock restricting the protruding tabs from movement out of the locking slot. Each rail and each frame includes a hole, with each such hole being aligned when each locking slot interlocked with one of the protruding tabs. The holes can have a fastener preventing the protruding tabs from sliding within the slots.

In a further embodiment of this assembly, each locking slot has an access opening for receiving an interlocking tab therethrough. For example, each access opening can face in an opposite direction to the support beam, thereby permitting the tab to enter the locking slot with movement towards the support beam. For example, each locking slot can be a retention slot that retains the protruding tab therein. Each protruding tab can include a shoulder, with the shoulder and a frame surface being on opposite faces of/straddling the slot when each locking slot is interlocked with one of the protruding tabs. In additional or alternative embodiments, each locking slot being elongated in a direction non-parallel to the center axis of the support beam, thereby permitting the tab to slide within the locking slot in the direction non-parallel center axis of the support beam. In additional or alternative embodiments, each protruding tab can be mushroom-shaped with a shoulder forming a head of the mushroom shape and an extension forming a stem of the mushroom shape. In additional or alternative embodiments, each protruding tab can include an extension extending away from a frame surface and defining a central axis, and a shoulder that extends away from the extension central axis, with the shoulder and the frame surface being on opposite faces of or straddling the slot and the extension extending through the slot when each locking slot is interlocked with one of the protruding tabs.

Another embodiment disclosed herein include a solar tracker assembly. This solar tracker assembly embodiment includes a plurality of foundations arranged in a row, at least one support beam extending along the row, a plurality of solar module assemblies being coupled to and rotated by the at least one support beam, and a plurality of rails coupling the plurality of solar module assemblies to the at least one support beam. The at least one support beam can define a central longitudinal axis extending therethrough and be pivotally mounted to the plurality of foundations, with the pivotal mounting permitting the at least one support beam to rotate about an axis of rotation parallel to the row. The rotation of the plurality of solar modules can orient the modules about the axis of rotation, with the solar module assemblies each including a frame and a solar module supported by the frame, with the frame having flange extending in a direction partially across an underside of the solar module, the flange having locking slots. The plurality of rails can be distributed at different longitudinal locations along the central longitudinal axis, with each rail having upright protruding tabs extending in a direction away from the at least one support beam. The locking slots can be sized to receive and interlock with one of the protruding tabs upon sliding within the slot, with each locking slot interlocked with one of the protruding tabs, and the interlock restricting the protruding tabs from movement out of the locking slot. Each rail and each frame can include a hole, and these holes can be aligned when each locking slot interlocked with one of the protruding tabs, with the holes having a fastener preventing the protruding tabs from sliding within the slots.

In a further embodiment of this assembly, each locking slot can be open in a direction facing the support beam and open in a direction facing away from the support beam. In an additional or alternative embodiment of this assembly, each locking slot can be elongated in a direction non-parallel to the center axis of the support beam, thereby permitting the protruding tab to slide within the locking slot in the direction non-parallel center axis of the support beam. In some examples, each locking slot can be a retention slot that retains the protruding tabs therein. In an additional or alternative embodiment of this assembly, each protruding tab can include a shoulder, and the shoulder and a frame surface can be on opposite faces of or straddling the slot when each when each locking slot is interlocked with one of the protruding tabs. In an additional or alternative embodiment of this assembly, each protruding tab can include an extension extending away from a frame surface and defining a central axis as well as a shoulder that extends away from the extension central axis, with the shoulder and the frame surface being on opposite faces of or straddling the slot and the extension extending through the slot when each locking slot is interlocked with one of the protruding tabs.

Another assembly embodiment includes a photovoltaic module, a pair of adjacent module rails, and at least one fastener. The photovoltaic module includes a glass laminate supported by an external metal frame, and the frame has a pair of opposing long sides and a pair of opposing shorts sides collectively forming a rectangular frame, with each long side has a pair of pins projecting outward away from the frame and terminating in a cap that has an outer diameter greater than an outer diameter of the pin. The pair of adjacent module rails are attached to a single-axis tracker torque tube, with each module rail including a pair of slots on opposing sides of the torque tube, the slots being substantially perpendicular to a main axis of the torque tube. The pins of the module frame can form a slot and pin mechanism to enable the photovoltaic module to move from an installation position to a seated position while the caps prevent lateral movement of the module within the slot in a direction of the main axis of the torque tube. The at least one fastener can pass through aligned holes of each rail and a corresponding one of the long sides of the rectangular frame proximate to one of the slots to secure the photovoltaic module in the seated position.

An assembly embodiment disclosed herein includes a solar module frame and a module support rail that is configured to couple to the solar module frame. The solar module frame includes a coupling tab. The module support rail includes a torque tube interface surface, a wall extending away from the torque tube interface surface, and a locking member that is movable relative to the wall. The wall includes a locking slot adjacent to the locking member. When the coupling tab is received at the locking slot, the locking member is configured to move relative to the wall to engage the coupling tab to thereby restrict movement of the solar module frame relative to the module support rail.

In a further embodiment of this assembly, when the coupling tab is received at the locking slot, the locking member is movable relative to the wall between an unlocked position, at which the locking member is spaced apart from the coupling tab and offset from the locking slot, and a locked position, at which the locking member engages the coupling tab and is aligned with the locking slot. In some examples, the locking slot is a first locking slot and the locking member is a first locking member, and the module support rail further includes a second locking slot at the wall and spaced apart along the wall from the first locking slot, where the module support rail further includes a second locking member that is movable relative to the wall and adjacent to the second locking slot. In some examples, the locking member includes a hook element that pivots between the unlocked position and the locked position. Also in some examples, the locking slot can extend along the wall in a first direction generally transverse to the torque tube interface surface and in a second direction generally parallel to the torque tube interface surface, with the extent of the locking slot in the first direction is greater than the extent of the locking slot in the second direction.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker;

FIG. 2 is a schematic, top view of a solar tracking system;

FIG. 3 is a schematic, perspective view of a solar tracker in accordance with the disclosure;

FIG. 4 is a schematic, perspective view of a portion of a solar tracker including a solar module and a module support rail in accordance with the disclosure;

FIG. 5 is a perspective view of the module support rail, in accordance with the disclosure;

FIG. 6 is a side view of a solar module frame, in accordance with the disclosure;

FIG. 7A is a first side view of the module support rail and the solar module in accordance with the disclosure;

FIG. 7B is an enlarged, second side view of the module support rail and the solar module, turned 90-degrees from the first side view, as in FIG. 7A;

FIGS. 8A to 8C illustrate a method of coupling a solar module frame to a module support rail, in accordance with the disclosure;

FIG. 9 is a schematic, perspective view of a portion of a solar tracker including a solar module in accordance with the disclosure;

FIG. 10A is a schematic, perspective view of a module support rail, in accordance with the disclosure;

FIG. 10B is an end view of the module support rail, as in FIG. 10A;

FIG. 11 illustrates a method of coupling a solar module frame to a module support rail, in accordance with the disclosure; and

FIGS. 12A-12F illustrate another embodiment of a module support rail for coupling to a solar module frame, in accordance with the disclosure. FIG. 12A is a perspective view of this module support rail embodiment coupled to a solar module frame. FIGS. 12B and 12C are, respectively, top and bottoms side perspective views of the solar module frame of FIG. 12A. FIG. 12D is a perspective view of the module support rail of FIG. 12A. FIGS. 12E and 12F illustrate a sequence for coupling the solar module frame of FIG. 12A to the module support rail of FIG. 12A.

FIG. 13 is a perspective view of another embodiment of a module support rail for coupling to a solar module frame, in accordance with the disclosure.

### DETAILED DESCRIPTION

The following detailed description is exemplary in nature and is not intended to limit the scope, applicability, or configuration of the disclosure in any way. Rather, the following description provides some practical illustrations for implementing examples of the present disclosure. Those skilled in the art will recognize that many of the noted examples have a variety of suitable alternatives.

Embodiments disclosed herein include various devices, systems, and methods relating to solar tracker foundations. Certain embodiments disclosed herein relate to solar module frames configured to facilitate improved structural stability for solar modules in solar tracking systems. Certain embodiments disclosed herein can improve solar tracking system structural stability while increasing the efficiency of solar module frame installation and reducing costs (e.g., frame and/or support material costs) associated with solar module frames and supports.

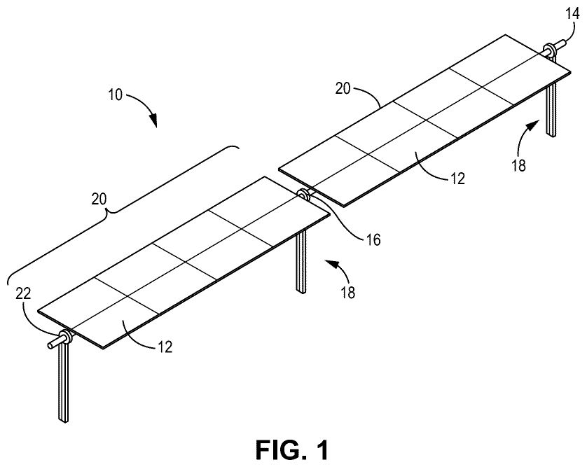

Referring now to the drawings, FIG. 1 illustrates a perspective view of a common arrangement of a solar tracker assembly 10 provided in accordance with the present disclosure. In some applications, a plurality of solar tracker assemblies 10 may be arranged in a north-south longitudinal orientation to form rows of a solar array. The solar tracker assembly 10 may be formed of a plurality of bays 20 defined by the distance between each foundation of a plurality of foundations 18 arranged in a row. The plurality of foundations 18 (generally referenced herein as foundations 18) may be disposed in spaced relation to one another and partially embedded in the earth. In some examples, the foundations 18 may be multi-component tubular support members, or A-frame supports, and/or may be configured to couple to A-frame supports. The foundations 18 may have one or more embedment in the ground, such as one for each leg of an A-frame support where the embedments are spaced apart in the east-west direction. FIG. 1 illustrates two bays 20 of the solar tracker assembly 10. However, it will be appreciated that the solar tracker assembly 10 may include four bays, six bays, ten bays, twenty bays, or any other suitable number of bays as desired. At each foundation 18 is either a bearing 22 or generally near the center of the solar tracker assembly 10 a drive mechanism 16. Each of the bearings 22 and the drive mechanism 16 are supported by one of the foundations 18. Activation of the drive mechanism rotates at least one support beam 14 about an axis of rotation and thus rotates a plurality of solar module assemblies 12 mounted to the at least one support beam 14 such that the plurality of solar module assemblies 12 can be oriented to a desired position. In some examples, the at least one support beam 14 may extend along the row of the solar array, defining a central longitudinal axis L1 extending therethrough, the at least one support beam 14 may be pivotally mounted to the foundations 18, the pivotal mounting permitting the at least one support beam 14 to rotate about an axis of rotation parallel to the row of the solar array. In some examples, the at least one support beam 14 may comprise a support beam, or two or more support beams configured to support the plurality of solar module assemblies 12. The desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker assembly 10 is located given the current weather and atmospheric conditions, the current demands of the grid, and other factors. The bearings 22 reduce to the extent possible the resistance to movement of the support beam 14 and the plurality of solar module assemblies 12.

In some examples, when the at least one support beam 14 is a support beam, the support beam may be sized (e.g., diameter, wall thickness, material) such that sag between the foundations 18 is reduced or substantially eliminated and to absorb torsional loads applied to the support beam by wind loading. In addition, since there is often just a single drive mechanism 16, the specifications for the support beam may desire to eliminate twist of the support beam along its length. Any twist would result in the plurality of solar module assemblies 12 being oriented differently from what is desired, and thus again reduce the output and efficiency of the solar tracker assembly 10, particularly, as the solar tracker assembly 10 is rotated to the extreme angles of permitted range (e.g., +/−75 degrees or more), for example, during stowing.

As will be appreciated, each of the plurality of solar module assemblies 12 must be supported on the at least one support beam 14. This is typically achieved by a bracket system (not shown in FIG. 1) that is attached to the at least one support beam 14 substantially perpendicular to the central longitudinal axis L₁ of the at least one support beam 14. The at least one support beam 14 may be rotatable about its central longitudinal axis L₁ to adjust an angular orientation of the plurality of solar module assemblies 12 relative to the sun, while supporting the plurality of solar module assemblies 12 on the bracket system. The bracket system may take many forms including two pieces of shaped steel, which may be arranged to sandwich the plurality of solar module assemblies 12, and may be configured to connect to a rail, which is then coupled to the at least one support beam 14.

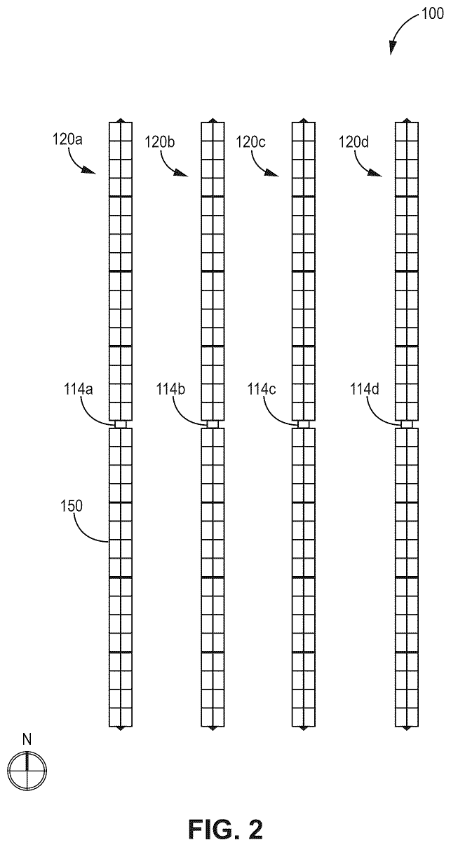

FIG. 2 is a top view of a solar tracker assembly 100 composed of a plurality of solar tracker rows, such as for example, a first solar tracker row 120a, a second solar tracker row 120b, a third solar tracker row 120c, and a fourth solar tracker row 120d (generally referred to herein as solar tracker rows 120). The solar tracker rows 120 may be arranged in parallel in a north-south direction, as shown in FIG. 2. It will be appreciated that directional language, e.g., north, south, east, west, referenced herein, is referring generally to such directions and not necessarily to the precise direction. For example, north-south, east-west directions may mean true north-south, true east-west, or approximately north, approximately south, approximately east, or approximately west, for example, within a ±44° range of true north-south, east-west. In some cases, the solar tracker rows 120 may include interior solar tracker rows, such as for example, solar tracker rows 120b, 120c, and exterior solar tracker rows, such as for example, solar tracker rows 120a, 120d. It will be appreciated that interior solar tracker rows are solar tracker rows 120 positioned between two other solar tracker rows 120, and exterior solar tracker rows are solar tracker rows 120 with one other solar tracker row 120 on one side of the exterior solar tracker row and no solar tracker row 120 positioned on the other side, opposite the one side of the exterior solar tracker row. The solar tracker rows 120 may be composed of a plurality of solar module assemblies 150 arranged in a north-south longitudinal orientation to form the solar tracker rows 120. The solar module assemblies 150 may include a plurality of solar modules, such as the solar modules 12, as in FIG. 1. The solar module assemblies 150 may each include edge protection against hail damage, as described further herein. Each one of the plurality of solar module assemblies 150 may be supported on a support beam 114a, 114b, 114c, 114d (generally referred to herein as support beam 114), which in turn is supported by a plurality of support piers (not explicitly shown in FIG. 2). The support beam 114 may be an example of the support beam 14, as in FIG. 1. As shown, the solar tracker rows 120 may be separated by a space sufficient to allow machinery to travel therethrough to allow for cleaning and maintenance.

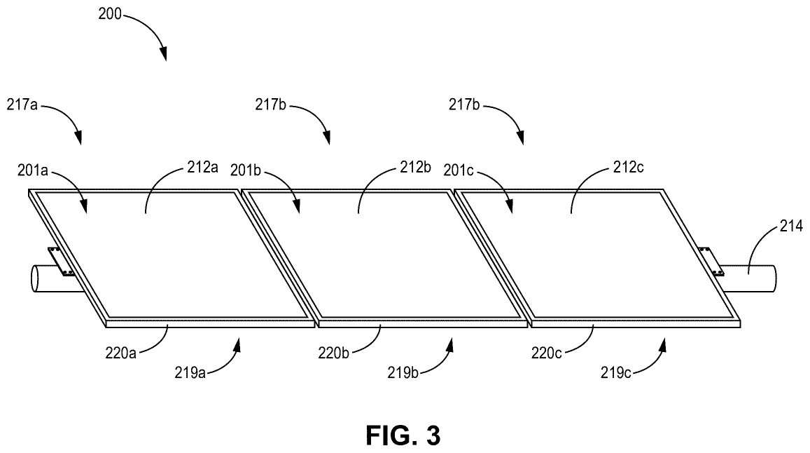

FIG. 3 is a schematic perspective view of a solar tracker assembly 200 in accordance with the disclosure. The solar tracker 200 may be an example of the solar tracker assembly 10, as in FIG. 1. The solar tracker assembly 200 may include a plurality of solar modules including a first solar module 212a, a second solar module 212b, and a third solar module 212c, generally referred to herein as plurality of solar modules 212. While it is shown that there are three solar modules, it may be contemplated that there may be six solar modules, eight solar modules, twenty solar modules, fifty solar modules, one hundred solar modules, or any other suitable number of solar modules, as desired. The first solar module 212a, the second solar module 212b, and the third solar module 212c may each include a solar module frame 220a, 220b, 220c, respectively. The solar module frames 220a, 220b, 220c may generally be referred to herein as a plurality of solar module frames 220. Each of the plurality of solar modules 212 may be coupled to a support beam 214 via a plurality of module support rails 240, described further with reference to FIG. 3B. Each one of the plurality of solar modules 212 may include a first end 217 (217a, 217b, 217c) and a second end 219 (219a, 219b, 219c). It will be appreciated that the description of the solar tracker assembly 10 with reference to FIG. 1, further applies to the solar tracker assembly 200.

Each one of the plurality of solar module frames 220 may have a top side 201 (201a, 201b, 201c) and a bottom side opposite the top side 201. The top side 201 of the plurality of solar module frames 220 can bound photovoltaic cells (e.g., photovoltaic cells included at a silicon laminate) and the bottom side of the plurality of solar module frames 220 can be configured to face the support beam 214. In some examples, the plurality of solar module frames 220 can be a steel frame having a 1.2 mm thickness.

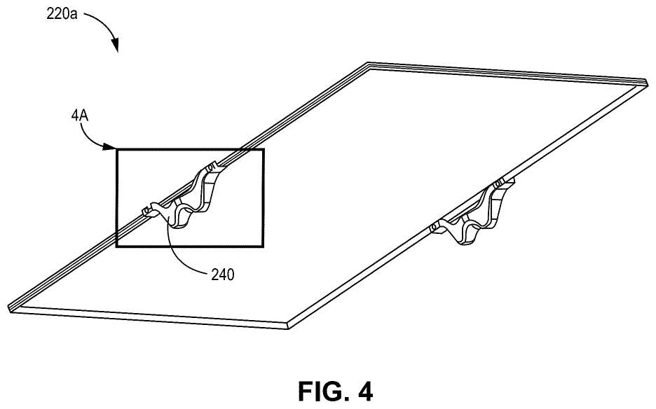

FIG. 4 is a schematic perspective view of a portion of the solar tracker assembly 200 including a solar module frame 220a and the module support rail 240. FIG. 4 illustrates that the module support rail 240 may be configured to receive one or more of the plurality of solar module frames 220 and to couple to the support beam 214 such that the module support rail 240 may be configured to couple one or more of the plurality of solar module frames 220 to the support beam 214. The module support rail 240 may have a lower portion that interfaces (e.g., contacts) the support beam 214 and an opposite upper portion that interfaces with one or more of the plurality of solar module frames 220. The lower portion of the module support rail 240 may have a profile that matches a cross-section of the support beam 214, which in the illustrated example the support beam 214 has a rounded (e.g., circular) cross-section and the lower portion of the module support rail 240 defines a semi-circular recessed cutout.

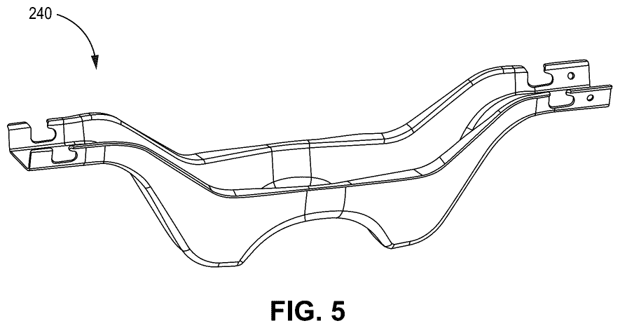

FIG. 5 is a schematic perspective view of the module support rail 240. The module support rail 240 may be configured to couple to one of the plurality of solar module frames 220 and to couple to the support beam 214 such that the module support rail 240 may be configured to couple one or more of the plurality of solar module frames 220 to the support beam 214. The illustrated embodiment shows the module support rail 240 may be configured to be coupled to two of the plurality of solar module frames 220.

The module support rail 240 may include a first end portion and an opposite second end portion. The first end portion and the second end portion may each include a flattened portion that are configured to contact and support the one or more of the plurality of solar module frames 220. The module support rail 240 may include a first upright wall and a second upright wall extending away from the support beam 214. The first upright wall and the second upright wall may be generally referred to herein as one or more sidewalls. The module support rail 240 may further define a channel between the one or more sidewalls.

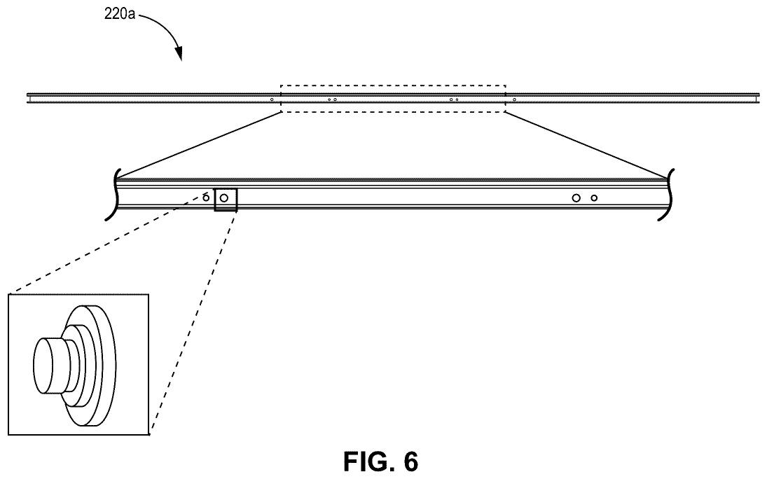

The one or more sidewalls (e.g., the first upright wall and the second upright wall) may define one or more locking slots. The one or more locking slots may include a first locking slot and a second locking slot. The one or more locking slots may be configured to engage with one or more protruding tabs of each one of the plurality of solar module frames 220, generally referred to herein as one or more tabs. Each locking slot may be a retention slot that retains the protruding tabs therein. The one or more tabs will be described further, with reference to FIG. 6. In some examples, the one or more locking slots may be incorporated into, or formed from, one or more slot reinforcement plates. The module support rail 240 may include the first locking slot and the first hole spaced apart along the length of the rail sidewall portion. In some examples, the rail sidewall portion may be angled at angle complementary to an angle of the frame side portion of the solar module frame. For instance, where the sidewalls at the module support rail 240 may taper inward toward the channel moving along the sidewalls toward the channel, the frame side portion may have a corresponding angular orientation to generally flushly move the frame side portion along the respective sidewall at the module support rail 240.

The first locking slot may include an access opening for receiving an interlocking tab therethrough and may be configured to engage with the tab of the solar module frame. The access opening may face in an opposite direction to the support beam, thereby permitting the tab to enter the locking slot with movement towards the support beam. In some examples, each locking slot may be elongated in a direction non-parallel to the center axis of the support beam, thereby permitting the tab to slide within the locking slot in the direction non-parallel center axis of the support beam. In some examples, the first locking slot may be considered to be an alignment slot, and the first locking slot and the tab of the solar module frame may be complementary and together be configured to guide correct placement of the first solar module frame 220a in east-west direction at the module support rail 240. The engagement of the first locking slot and the tab may be useful in both providing for east-west direction alignment between the first solar module frame 220a and the module support rail 240 in an efficient manner that can reduce installation time and reduce a number of fastening connections needing to be made between the first solar module frame 220a and the module support rail 240 once the first solar module frame 220a is landed at the module support rail 240 (e.g., when the tab is at the first locking slot). For example, engagement of the first locking slot and the tab may further serve to securely fasten the first solar module frame 220a to the module support rail 240 by the tab protruding into and through the first locking slot and sliding into a locked position

The second end portion of the module support rail 240 may include one or more holes. The one or more holes may include a first hole and a second hole. The one or more holes may be configured to align with respective holes of the plurality of solar module frames 220. Alignment of the one or more holes with the holes of the plurality of solar module frames 220 permits placement of a fastener therethrough. The fastener may be one of: rivets, nuts and bolts, a bobtail fastener, a clinch joint, a flow drill screw, or the like.

While it is shown that the one or more holes are positioned adjacent to the second end portion of the module support rail 240, it will be appreciated that the one or more holes may be positioned adjacent the first end portion of the module support rail 240. In either configuration, it will be appreciated that each module support rail 240 in an entirety of a solar tracker row (e.g., solar tracker row 120) will be uniformly arranged (e.g., all of the one or more holes will be at the same end portion of each module support rail 240)

FIG. 6 is a schematic side view of the first solar module frame 220a. The first solar module frame 220a may include a frame side portion. In some examples, as shown in FIG. 6, the frame side portion may include a first protruding tab and a second protruding tab. Each of the one or more tabs may be inserted through a slot on the module support rail 240, although the slot is not explicitly shown in FIG. 6. The first tab and the second tab may be incorporated into, or formed from, a first tab reinforcement plate, and the second tab may be incorporated into, or formed from, the second tab reinforcement plate, however this is not necessary. In some examples, the first tab and the second tab may each be formed from the frame side portion or may be coupled to the frame side portion via one or more fastening mechanisms, such as, an adhesive, a fastener, or the like. In some examples, the addition of the one or more tab reinforcement plates increases the thickness of the frame side portion, thereby increasing the strength of the solar module frame 220a, without increasing the thickness, and thereby cost, of the entirety of the solar module frame 220a.

The frame side portion may include the first tab, and a first hole spaced apart along the length of the frame side portion. In some examples, the frame side portion may be angled at angle complementary to an angle of the sidewall of the module support rail 240. For instance, where the sidewalls at the module support rail 240 may taper inward toward the channel moving along the sidewalls toward the channel, the frame side portion may have a corresponding angular orientation to generally flushly move the frame side portion along the respective sidewall at the module support rail 240. In addition to the frame side portion, the first solar module frame 220a may include a photovoltaic laminate receptacle and base portion opposite the receptacle. Thus, frame side portion may be located between the receptacle and the base portion, and frame side portion may be at an angle relative to the base portion (e.g., an angle may range from greater than ninety degrees to less than one hundred and eighty degrees, such as ranging from greater than ninety degrees up to one hundred and twenty degrees).

The first hole may be configured to align with the second hole of the one or more holes of the module support rail 240. Alignment of the first hole with the second hole of the module support rail 240 may permit a fastener to extend through both the first hole and the second hole to further secure the first solar module frame 220a to the module support rail 240. The fastener may be one of: rivets, nuts and bolts, a bobtail fastener, a flow drill screw, or the like. In some examples, the first solar module frame 220a may not include the first hole but may rather be secured to the module support rail 240 via a clinch joint. In such examples, when a clinch joint is used, no fasteners would be used to secure the first solar module frame 220a to the module support rail 240.

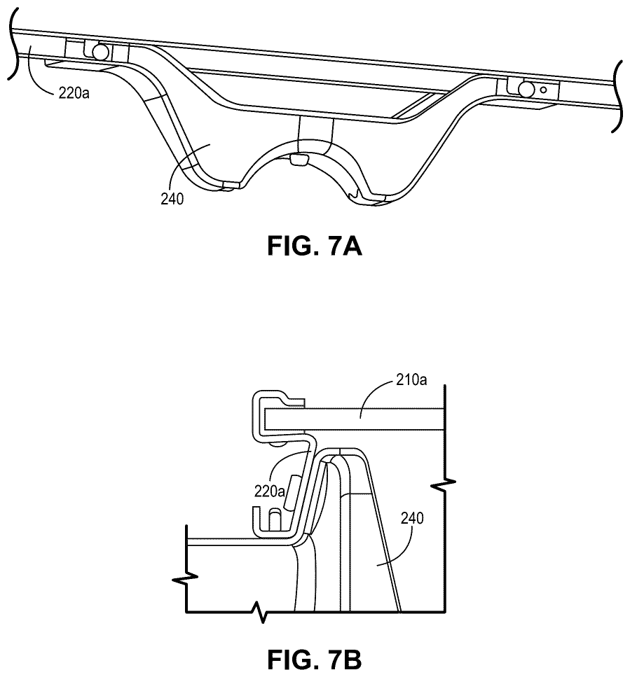

FIG. 7A is a first side view of the module support rail 240 and the solar module frame 220a, and FIG. 7B is an enlarged, second side view of the module support rail 240 and the solar module frame 220a, turned 90-degrees from the first side view. As shown, the solar module frame 220a has two integrated tabs. While only one side of the solar module frame 220a is shown in FIGS. 7A and 7B, it will be appreciated that a second side, opposite the side shown, further includes two integrated tabs. The module support rail 240 includes two slots that correspond to the integrated tabs on the solar module frame 220a. The solar module is installed by landing the tabs of the module frame into the corresponding slots on the module support rail 240. The solar module then gets pushed into place, and one fastener per side is used to prevent the solar module from backing out of its installed position.

As shown in FIG. 7A, the first locking slot may include a thin locking slot and a deep locking slot. The deep locking slot may include a width and height sufficient to permit the tab to protrude into and therethrough the first locking slot such that the tab has passed through the locking slot. Once the tab has protruded therethrough, the frame side portion of the first solar module frame 220a may move along the respective sidewall at the module support rail 240 thereby positioning the tab within the thin locking slot and locking the first solar module frame 220a in position. In some examples, each protruding tab may include an extension extending away from a frame surface and defining a central axis, and a shoulder that extends away from the extension central axis, the shoulder and the frame surface being on opposite faces of or straddling the slot and the extension extending through the slot when each locking slot is interlocked with one of the protruding tabs. The tab may further include a flange. The tab shoulder may include a diameter that is greater than a locking slot diameter, so an interference fit is added to the slot joint to prevent further movement of the solar module frame 220a with reference to the module support rail 240. The flange of the tab may serve to prevent movement of the solar module in a north-south direction. In some examples, each protruding tab may be mushroom-shaped with a shoulder forming a head of the mushroom shape and an extension forming a stem of the mushroom shape. In some examples, the tabs within the locking slots, per long edge of the solar module frame, may be the major tensile load bearing system.

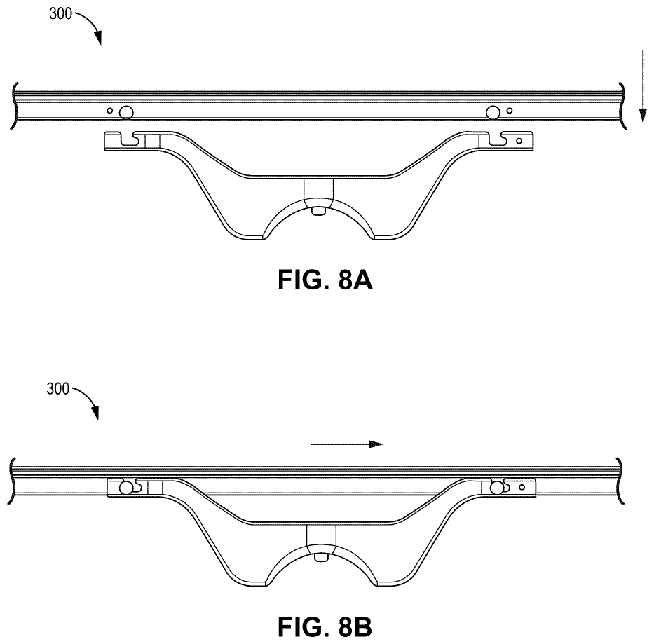

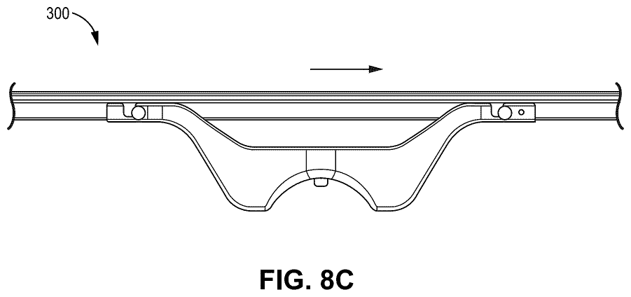

FIGS. 8A to 8C illustrate a method 300 of coupling the first solar module frame to the module support rail, in accordance with the disclosure. While FIGS. 8A to 8C illustrate coupling the first solar module frame 220a to the module support rail 240, it will be appreciated that method 300 may be utilized for coupling each of the plurality of solar module frames 220 to any module support rail 240 positioned along the length of the support beam 214. The first solar module frame 220a and the module support rail 240 are simply used for illustration purposes.

As shown in FIG. 8A, the first solar module frame 220a, and thereby the first solar module, may be positioned above the module support rail 240. The tab of the first solar module frame 220a may be lined up above the locking slot of the module support rail 240. The first solar module frame 220a may then be lowered onto the module support rail 240, as indicated by the arrow. As such, the tab may pass into the locking slot as the first solar module frame 220a lands onto the module support rail 240. When the tab is positioned within the locking slot, the first solar module frame 220a may be considered to be in an unlocked position. In the unlocked position, a first hole of the first solar module frame 220a may not be fully aligned with a second hole of the module support rail 240, thereby preventing a fastener from being positioned therethrough.

Step two, as shown in FIG. 8B, may include sliding the first solar module frame 220a along a respective sidewall at the module support rail 240, as indicated by the arrow, thereby fully engaging the tab with the locking slot and locking the first solar module frame 220a in a locked position. In the locked position, the first hole of the first solar module frame 220a may be fully aligned with the second hole of the module support rail 240, thereby permitting placement of a fastener therethrough. In some examples, a clinch joint, a blind rivet, or any other suitable type of fastener, may be used to secure the first solar module frame 220a to the module support rail 240. In some examples, the first solar module frame 220a may be coupled to the module support rail 240 via the fastener.

When the first solar module frame 220a and the module support rail 240 are in the locked position, as shown in FIG. 8C, a wind load that may be exerted upon the first solar module 212a may be transferred to the tab as the wind pushes up on the first solar module 212a. When the wind load pushes down on the first solar module 212a, the wind load will be transferred to the module support rail 240.

While FIGS. 3 to 8C make reference to the first solar module frame 220a, the module support rail 240, and respective components thereof, it will be appreciated that the description of the first solar module frame 220a, the module support rail 240, and respective components thereof may further apply to each of the plurality of solar module frames 220, any module support rail 240 along the length of the support beam 214, and any respective components thereof (e.g., tabs, slots, slot reinforcement plates, tab reinforcement plates, etc.). The first solar module frame 220a, the module support rail 240, and respective components thereof, are simply used for illustration purposes.

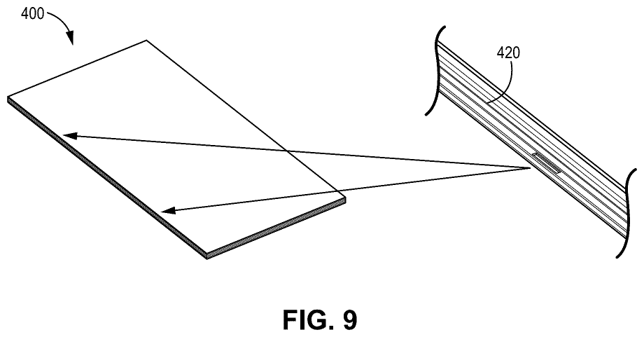

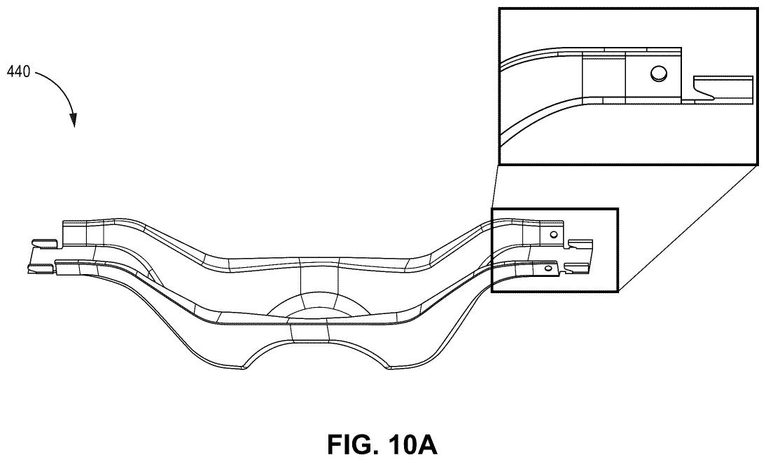

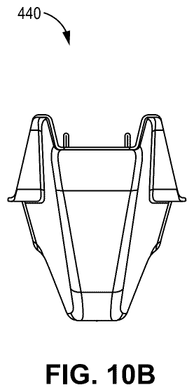

FIG. 9 is a schematic perspective view of a solar module 400 including a solar module frame 420, in accordance with the disclosure. FIG. 10A is a schematic perspective view of a module support rail 440, and FIG. 10B is an end view of the module support rail 440. The solar module frame 420 and the module support rail 440 may be like the solar module frame 220 and the module support rail 440 described with reference to FIGS. 3 to 8C, however, the locking slot is included on the solar module frame 420, and the one or more tabs are included on the module support rail 440.

The module support rail 440 may include a first end portion and an opposite second end portion. The first end portion and the second end portion may each include a flattened portion that are configured to contact and support the solar module frame 420. The module support rail 440 may include one or more sidewalls. The module support rail 440 may further define a channel between the one or more sidewalls.

The first end portion and the second end portion may each include one or more tabs. The one or more tabs may include a first tab, a second tab, a third tab, and a fourth tab. The one or more tabs may be configured to engage with one or more locking slots set into the solar module frame 420. The one or more tabs may be incorporated into, or formed from the module support rail 440. The module support rail 440 may further include one or more holes. The one or more holes may include a first hole and a second hole. The one or more holes may be configured to align with respective holes of the solar module frame 420. Alignment of the one or more holes with the holes of the solar module frame 420 permits placement of a fastener therethrough. The fastener may be one of: rivets, nuts and bolts, a bobtail fastener, a clinch joint, a flow drill screw, or the like.

While it is shown that the one or more holes are positioned adjacent the second end portion of the module support rail 440 and the one or more tabs are positioned adjacent the first end portion and the second end portion of the module support rail 440, it will be appreciated that the one or more holes may be positioned adjacent the first end portion of the module support rail 440. In either configuration, it will be appreciated that each module support rail 440 in an entirety of a solar tracker row (e.g., solar tracker row 120) will be uniformly arranged.

As shown in FIG. 9, the solar module frame 420 may include a locking slot that may be one of one or more locking slots that may be set into each one of a plurality of solar module frames 420. In some examples, each locking slot may be open in a direction facing the support beam and open in a direction facing away from the support beam. The locking slot may be a retention slot being elongated in a direction non-parallel to the center axis of the support beam, thereby permitting the protruding tab to slide within the locking slot in the direction non-parallel center axis of the support beam.

The solar module frame 420 may include a frame side portion. The frame side portion may include the first locking slot, the second locking slot, and the first hole spaced apart along the length of the frame side portion. In some examples, the frame side portion may be angled at angle complementary to an angle of the sidewall of the module support rail 440. For instance, where the sidewalls at the module support rail 440 may taper inward toward the channel moving along the sidewalls toward the channel, the frame side portion may have a corresponding angular orientation to generally flushly move the frame side portion along the respective sidewall at the module support rail 440. In addition to the frame side portion, the solar module frame 420 may include a photovoltaic laminate receptacle and base portion opposite the receptacle. Thus, frame side portion may be located between the receptacle and the base portion, and frame side portion may be at an angle relative to the base portion (e.g., an angle may range from greater than ninety degrees to less than one hundred and eighty degrees, such as ranging from greater than ninety degrees up to one hundred and twenty degrees).

The first locking slot may be configured to engage with the second tab of the module support rail 440. In some examples, the first locking slot may be considered to be an alignment slot, and the first locking slot and the tab of the module support rail 440 may be complementary and together be configured to guide correct placement of the solar module frame 420 in east-west direction at the module support rail 440. The engagement of the first locking slot and the second tab may be useful in both providing for east-west direction alignment between the solar module frame 420 and the module support rail 440 in an efficient manner that can reduce installation time and reduce a number of fastening connections needing to be made between the solar module frame 420 and the module support rail 440 once the solar module frame 420 is landed at the module support rail 440.

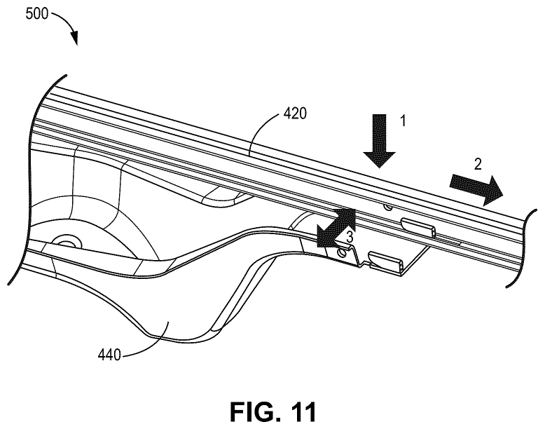

FIG. 11 illustrates a method 500 of coupling the solar module frame 420 to the module support rail 440, in accordance with the disclosure. Although not explicitly shown in FIG. 11, the solar module frame 420, and thereby a solar module, may be positioned above the module support rail 440. The locking slot of the solar module frame 420 may be lined up above the tab of the module support rail 440. The solar module frame 420 may then be lowered onto the module support rail 440, as indicated by arrow 1. As such, the tab may pass into the locking slot as the solar module frame 420 lands onto the module support rail 440. When the tab is positioned within the locking slot, the solar module frame 420 may be considered to be in an unlocked position. In the unlocked position, a first hole of the solar module frame 420 may not be fully aligned with a second hole of the module support rail 440, thereby preventing a fastener from being positioned therethrough.

Step two may include sliding the solar module frame 420 along a respective sidewall at the module support rail 440, as indicated by arrow 2, thereby fully engaging the tab with the locking slot and locking the solar module frame 420 in a locked position. In the locked position, the first hole of the solar module frame 420 may be fully aligned with the second hole of the module support rail 440, thereby permitting placement of a fastener therethrough. In some examples, a clinch joint, a blind rivet, or any other suitable type of fastener, may be used to secure the solar module frame 420 to the module support rail 440. In some examples, the solar module frame 420 may be coupled to the module support rail 440 via the fastener.

When the solar module frame 420 and the module support rail 440 are in the locked position, a wind load that may be exerted upon the solar module may be transferred to the tab as the wind pushes up on the solar module. When the wind load pushes down on the solar module, the wind load will be transferred to the module support rail 40.

The example solar module frames (220, 420) and the components thereof described herein may be formed from a sheet metal, such as a steel sheet. In some examples, the solar module frames (220, 420) and the components thereof may be formed from aluminum, such as by extruding aluminum. In some examples, the solar module frames (220, 420) and the components thereof may be formed from titanium, stainless steel, nickel alloys, platinum, or the like. The solar module frames (220, 420) and the components thereof may be formed by bending with bends or folds to form the desired profile.

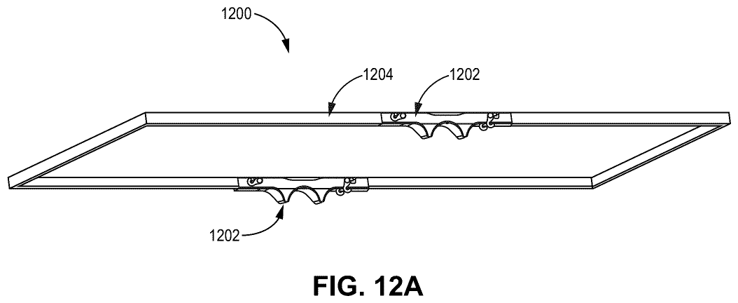

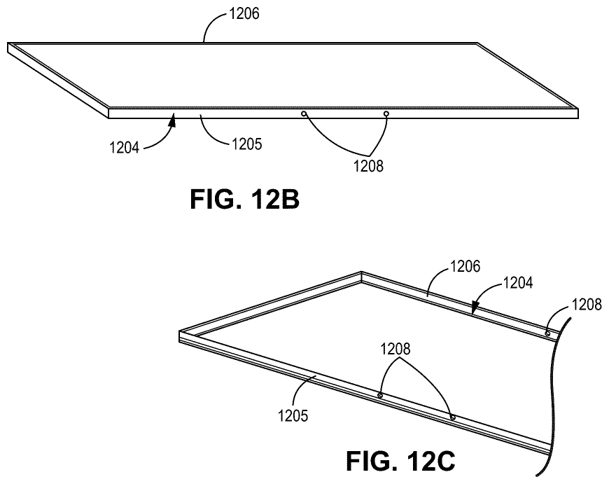

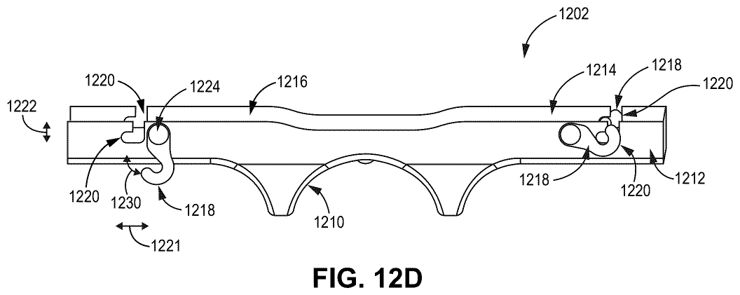

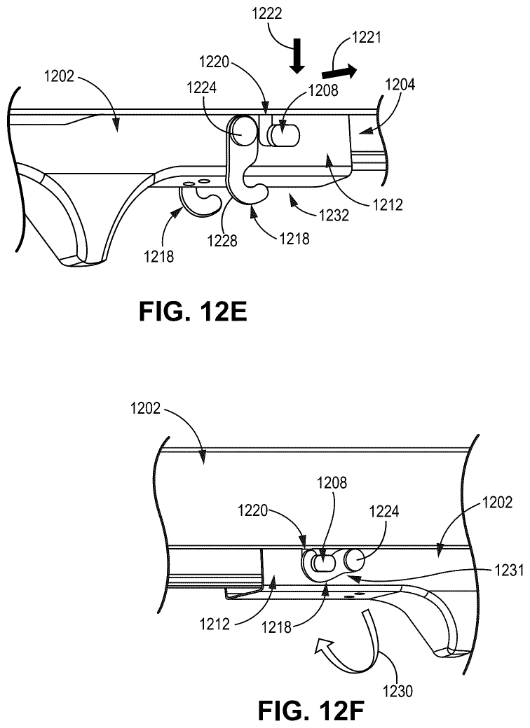

FIGS. 12A-12F illustrate another embodiment of a module support rail 1202 for coupling to a solar module frame 1204.

FIG. 12A is a perspective view of an assembly 1200 that includes the module support rail 1202 and the solar module frame 1204. The module support rail 1202 is configured to receive and retain the solar module frame 1204. As will be described further in reference to other drawings, as the solar module frame 1204 is placed at the module support rail 1202, the module support rail 1202 can be configured to engage one or more structures at the solar module frame 1204 to thereby couple the solar module frame 1204 to the module support rail 1202. FIG. 12A shows two module support rails 1202 coupled to the solar module frame 1204 at opposite longitudinal sides of the solar module frame 1204. In this arrangement, the pair of module support rails 1202 can retain the solar module frame 1204 in place relative to the pair of module support rails 1202 at opposite sides of the solar module frame 1204. And the module support rail(s) 1202 can be configured to provide this coupling to and retention of the solar module frame 1204 in a manner that reduces components parts and reduces solar tracker system installation time, effort, and cost.

FIGS. 12B and 12C are, respectively, top and bottom side perspective views of the solar module frame 1204. The solar module frame 1204 can include a first longitudinal side 1205 and a second, opposite longitudinal side 1206. Each longitudinal side 1205, 1206 can include one or more coupling tabs 1208. The illustrated embodiment shows the first longitudinal side 1205 as including two coupling tabs 1208, and the second longitudinal side 1206 can likewise include two coupling tabs 1208 (e.g., each axially aligned with the respective one of pair of coupling tabs 1208 at the first longitudinal side 1205).

The coupling tab(s) 1208 at the solar module frame 1204 can be configured to engage the module support rail 1202. For example, as shown for the illustrated embodiment, the coupling tab 1208 can project out from the longitudinal side 1205 or 1206 and this projected structure of the coupling tab 1208 can be configured to be received at the module support rail 1202. For instance, as described further herein, the projected structure of the coupling tab 1208 can be configured to engage with both a locking slot and a locking member at the module support rail. As shown for the illustrated embodiment, the longitudinal side 1205 can include one or more coupling tabs 1208 (e.g., a pair of coupling tabs 1208) and the opposite longitudinal side 1206 can include one or more coupling tabs 1208 (e.g., a pair of coupling tabs 1208). The coupling tab(s) 1208 can extend out from each of a front side of the respective longitudinal side 1205 or 1206, as in FIG. 12A, and an opposite back side of the respective longitudinal side 1205 or 1206, as in FIG. 12B. In this way, the solar module frame 1204 can be configured to engage with the module support rail 1202 at each of the front and back sides of a given longitudinal side 1205, 1206 of the solar module frame 1204. In some examples, the coupling tab 1208 can be a pin component extending out from the longitudinal side 1205 or 1206 of the solar module frame 1204 at each of the front and back sides of the corresponding longitudinal side 1205 or 1206.

FIG. 12D is a perspective view of the module support rail 1202 that can be configured to couple to a solar module frame, such as the frame 1204. The module support rail 1202 includes a torque tube interface surface 1210, a first wall 1212, and a second wall 1214. The torque tube interface surface 1210 can be configured to interface with a solar tracker torque tube such that the module support rail 1202 can couple to and sit, directly or indirectly, at the torque tube. The torque tube interface surface 1210 can define a profile at the module support rail 1202 that corresponds to a geometric cross-sectional shape of the torque tube. For example, as illustrated here, where the torque tube defines a generally circular cross-sectional shape, the torque tube interface surface 1202 can define a semi-circular profile that is configured to saddle the torque tube. The first wall 1212 and the second wall 1214 can be spaced apart from one another about the module support rail 1202. For example, the first and second walls 1212, 1214 can be spaced apart from one another to define a channel 1216 therebetween. As another example, each of the first and second walls 1212, 1214 can extend in a direction up and away from the torque tube interface surface 1210.

As also shown at FIG. 12D, the module support rail 1202 can further include one or more locking slots 1220. The one or more locking slots 1220 can each be configured to receive the solar module frame 1204. As one such example, the one or more locking slots 1220 can each be configured to receive thereat a respective coupling tab 1208 of the solar module frame 1204. The one or more locking slots 1220 can be included at the first and/or second wall 1212, 1214. For example, the locking slot 1220 can extend along the wall 1212 in a first direction 1221 that is generally transverse to the torque tube interface surface 1210, and the locking slot 1220 can extend along the wall 1212 in a second direction 1222 that is generally parallel to the torque tube interface surface 1210. As shown for the illustrated embodiment, the extent of the locking slot 1220 in the first direction 1221 can be greater than the extent of the locking slot 1220 in the second direction 1222. The illustrated embodiment shows an example where the module support rail 1202 includes four locking slots 1220—two locking slots 1220 defined at the wall 1212 and two locking slots 1202 defined art the wall 1214. As illustrated, one of the locking slots 1220 at the wall 1212 can be axially aligned with one of the locking slots 1220 at the wall 1214, and the other of the locking slots 1220 at the wall 1212 can be axially aligned with the other of the locking slots 1220 at the wall 1214.

As further shown at FIG. 12D, the module support rail 1202 can further include one or more locking members 1218. The one or more locking members 1218 can each be configured to engage the solar module frame 1204 to thereby help restrict relative movement between the solar module frame 1204 and the module support rail 1202. As one such example, the one or more locking members 1218 can each be configured to engage a respective coupling tab 1208 of the solar module frame 1204. The one or more locking members 1218 can be included at the first and/or second wall 1212, 1214. For example, to engage a respective coupling tab 1208, each of the one or more locking members 1218 can be movably coupled to a respective wall 1212 or 1214 adjacent to a respective locking slot 1220 to move the respective locking member 1218 into engagement with the corresponding, adjacently placed coupling tab 1208. The illustrated embodiment at FIG. 12D shows a pair of locking members 1218 each movably coupled to the first wall 1212 adjacent to a corresponding locking slot 1220 at the first wall 1212 and a pair of locking members 1218 each rotatably coupled to the second wall 1214 adjacent to a corresponding locking slot 1220 at the second wall 1214. In this arrangement, the pair of locking members 1218 at the first wall 1212 can be moved into engagement with the respective coupling tab 1208 received at the adjacent locking slot 1220 at the first wall 1212, and the pair of locking members 1218 at the second wall 1214 can be moved into engagement with the respective coupling tab 1208 received at the adjacent locking slot 1220 at the second wall 1214. Accordingly, the locking member 1218 can be configured to move relative to the wall 1212 or 1214 to engage the coupling tab 1208 of the solar module frame 1204 to thereby restrict movement of the solar module frame 1204 relative to the module support rail 1202.

More specifically, the illustrated example of the module support rail 1202 includes each of the one or more locking members 1218 rotatably coupled to a respective wall 1212 or 1214 adjacent to a respective locking slot 1220. Each of the one or more locking members 1218 can be coupled to the wall 1212 or 1214 via a rotatable connection 1224. As such, each of the one or more locking members 1218 can rotate about the rotatable connection 1224, in directions 1230, relative to the wall 1212 or 1214 and relative to each of the locking slot 1220 and coupling tab 1208 received at the locking slot 1220. Thus, the locking member 1218 can pivot or swing about the rotatable connection 1224 and relative to the wall 1212 or 1214 in directions 1230 to engage and disengage the coupling tab 1208 received at the locking slot 1220.

FIGS. 12E and 12F illustrate an exemplary sequence for coupling the solar module frame 1204 to the module support rail 1202. At FIG. 12E, first the coupling tab 1208 of the solar module frame 1204 can be placed relative to the module support rail 1202 such that the coupling tab 1208 of the solar module frame 1204 is received at the locking slot 1220 of the module support rail 1202. The locking member 1218 can be at an unlocked position 1232 when the coupling tab 1208 of the solar module frame 1204 is placed and received at the locking slot 1220 of the module support rail 1202 (e.g., FIG. 12E). The coupling tab 1208 of solar module frame 1204 can be first dropped into the locking slot 1220 in the direction 1222 and then slid relative to the locking slot 1220 in the direction 1221 such that the coupling tab 1208 is moved to a position relative to the locking slot 1220 where the coupling tab 1208 is restricted from movement relative to the rail 1202 by the locking slot 1220 in at least two directions (e.g., restricted from movement relative to the rail 1202 by the locking slot 1220 in a least three directions that include to the right of the coupling tab 1208 at FIG. 12E, above the coupling tab 1208 at FIG. 12E, and below the coupling tab 1208 at FIG. 12E).

When the coupling tab 1208 is received at the locking slot 1220, the locking member 1208 can be moved, relative to the wall 1212, between unlocked position 1230, at which the locking member 1218 is spaced apart from the coupling tab 1208 and offset from the locking slot 1220, and a locked position 1231, at which the locking member 1218 engages the coupling tab 1208 and is aligned with the locking slot 1220 (e.g., FIG. 12F). For example, the locking member 1218 can include a hook element 1228 that is rotationally moveable relative to the wall 1212 such that the hook element 1228 pivots or swings between the unlocked position 1232 and the locked position 1231. When the locking member 1218 is moved to the locked position 1231, the locking member 1218 can act to restrict movement of the coupling tab 1208, and thus the solar module frame 1204, at least in a direction the coupling tab 1208 was not previously restricted when the locking member 1218 was at the unlocked position 1232 (e.g., the locking member 1218 in the locked position 1231 is configured to restrict movement of the coupling tab 1208, and thus frame 1204, relative to the rail 1202 at least in the direction that includes to the left of the coupling tab 1208 at FIG. 12E-12F).

Accordingly, the module support rail 1202 and solar module frame 1204 can be configured to enable coupling therebetween in a manner that provides structural stability between the rail 1202 and the frame 1204 but yet does so in a manner that reduces components, installation time, and costs associated with installation a solar tracker system.

Also within the scope of this disclosure are various methods of coupling a solar module frame to a rail. Such method embodiments can include one or more steps of placing a solar module frame at a rail and then coupling that solar module frame to the rail. One such example of a method can include the sequence illustrated and described previously in reference to FIGS. 12E and 12F.

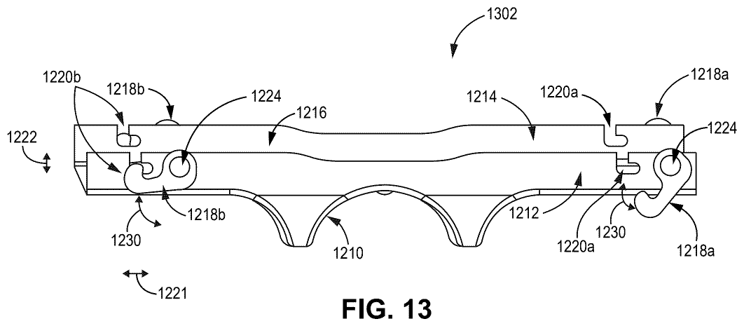

FIG. 13 is a perspective view of another embodiment of a module support rail 1302 for coupling to a solar module frame, such as the solar module frame 1204 disclosed previously herein. Except as otherwise illustrated at, or described in reference to, FIG. 13, the module support rail 1302 can be similar to, or the same as, the module support rail 1202 disclosed elsewhere herein.

As shown at the embodiment of FIG. 13, the module support rail 1302 can include one or more locking members 1218a, 1218b and one or more locking slots 1220a, 1220b. In particular, the illustrated embodiment of the module support rail 1302 includes a pair of locking members 1218a and adjacent pair of locking slots 1220a at one side of the module support rail 1302 and aligned across opposite walls 1212, 1214, and the module support rails 1302 further includes a pair of locking members 1218b and adjacent pair of locking slots 1220b at another, opposite side of the module support rail 1302 and aligned across opposite walls 1212, 1214.

This illustrated embodiment of the module support rail 1302 includes the pair of locking slots 1220b extending in the direction 1221 toward the torque tube interface surface 1210. Namely, the pair of locking slots 1220b can extend down from the top of respective wall 1212, 1214 in the direction 1222 and then from this downward extension in the direction 1222, the pair of locking slots 1220b can extend in the direction 1221 toward the torque tube interface surface 1210. As shown here, the corresponding locking members 1218b can be rotatably connected 1224 at the respective wall 1212, 1214 adjacent to a terminal end of the corresponding locking slots 1220b in the direction 1221—here the locking members 1218b are rotatably connected at the respective wall 1212, 1214 at a side of the corresponding locking slot 1220b between the corresponding locking slot 1220b and the torque tube interface surface 1210. In addition, this illustrated embodiment of the module support rail 1302 includes the pair of locking slots 1220a extending in the direction 1221 away from the torque tube interface surface 1210. Namely, the pair of locking slots 1220a can extend down from the top of respective wall 1212, 1214 in the direction 1222 and then from this downward extension in the direction 1222, the pair of locking slots 1220a can extend in the direction 1221 away from the torque tube interface surface 1210. As shown here, the corresponding locking members 1218a can be rotatably connected 1224 at the respective wall 1212, 1214 adjacent to a terminal end of the corresponding locking slots 1220a in the direction 1221—here the locking members 1218a are rotatably connected at the respective wall 1212, 1214 at a side of the corresponding locking slot 1220a opposite the torque tube interface surface 1210.

As disclosed elsewhere herein, the one or more locking slots 1220a, 1220b can each be configured to receive the solar module frame 1204, and the one or more locking members 1218a, 1218b can each be configured to engage the solar module frame 1204 at the corresponding locking slot 1220a, 1220b to couple the solar module frame 1204 to the module support rail 1302. As one such example, the one or more locking slots 1220a, 1220b can each be configured to receive thereat a respective coupling tab 1208 of the solar module frame 1204. Each of the one or more locking members 1218a, 1218b can rotate about the rotatable connection 1224, in directions 1230, relative to the respective wall 1212 or 1214 and relative to corresponding, adjacent the locking slot 1220a, 1220b to engage the coupling tab 1208 received at the corresponding locking slot 1220a 1220b. Thus, the locking member 1218a, 1218b can pivot or swing about the rotatable connection 1224 and relative to the respective wall 1212 or 1214 in directions 1230 to engage and disengage the coupling tab 1208 received at the locking slot 1220a or 1220b. For instance, this can be similar to that illustrated at, and described previously in reference to, FIGS. 12E and 12F.

Various non-limiting exemplary embodiments have been described. It will be appreciated that suitable alternatives are possible without departing from the scope of the examples described herein.

What is claimed is:

1. A solar tracker assembly comprising:
a plurality of foundations arranged in a row;
at least one support beam extending along the row, defining a central longitudinal axis extending therethrough, and pivotally mounted to the plurality of foundations, the pivotal mounting permitting the at least one support beam to rotate about an axis of rotation parallel to the row;
a plurality of solar module assemblies being coupled to and rotated by the at least one support beam, the rotation of the plurality of solar modules orienting the modules about the axis of rotation, the solar module assemblies each including a frame and a solar module supported by the frame, the frame having a protruding tab,
a plurality of rails coupling the plurality of solar module assemblies to the at least one support beam, the plurality of rails being distributed at different longitudinal locations along the central longitudinal axis, each rail having a first upright wall and a second upright wall extending away from the at least one support beam and forming a channel therebetween,
the first upright wall defining locking slots, each locking slot sized to receive and interlock with one of the protruding tabs upon sliding within the slot, each locking slot interlocked with one of the protruding tabs, the interlock restricting the protruding tabs from movement out of the locking slot; and
each rail and each frame having a hole, the holes being aligned when each locking slot interlocked with one of the protruding tabs, the holes having a fastener preventing the protruding tabs from sliding within the slots.

2. The solar tracker assembly of claim 1, wherein each locking slot has an access opening for receiving an interlocking tab therethrough.

3. The solar tracker assembly of claim 2, wherein each access opening facing in an opposite direction to the support beam, thereby permitting the tab to enter the locking slot with movement towards the support beam.

4. The solar tracker assembly of claim 2, wherein each locking slot being elongated in a direction non-parallel to the center axis of the support beam, thereby permitting the tab to slide within the locking slot in the direction non-parallel center axis of the support beam.

5. The solar tracker assembly of claim 2, wherein each locking slot is a retention slot that retains the protruding tabs therein.

6. The solar tracker assembly of claim 2, wherein each protruding tab having a shoulder, the shoulder and a frame surface being on opposite faces of/straddling the slot when each when each locking slot is interlocked with one of the protruding tabs.

7. The solar tracker assembly of claim 2, wherein each protruding tab is mushroom-shaped with a shoulder forming a head of the mushroom shape and an extension forming a stem of the mushroom shape.

8. The solar tracker assembly of claim 2, wherein each protruding tab has an extension extending away from a frame surface and defining a central axis, and a shoulder that extends away from the extension central axis, the shoulder and the frame surface being on opposite faces of or straddling the slot and the extension extending through the slot when each locking slot is interlocked with one of the protruding tabs.

9. A solar tracker assembly comprising:
a plurality of foundations arranged in a row;
at least one support beam extending along the row, defining a central longitudinal axis extending therethrough, and pivotally mounted to the plurality of foundations, the pivotal mounting permitting the at least one support beam to rotate about an axis of rotation parallel to the row;
a plurality of solar module assemblies being coupled to and rotated by the at least one support beam, the rotation of the plurality of solar modules orienting the modules about the axis of rotation, the solar module assemblies each including a frame and a solar module supported by the frame, the frame having flange extending in a direction partially across an underside of the solar module, the flange having locking slots;
a plurality of rails coupling the plurality of solar module assemblies to the at least one support beam, the plurality of rails being distributed at different longitudinal locations along the central longitudinal axis, each rail having upright protruding tabs extending in a direction away from the at least one support beam,
the locking slots sized to receive and interlock with one of the protruding tabs upon sliding within the slot, each locking slot interlocked with one of the protruding tabs, the interlock restricting the protruding tabs from movement out of the locking slot; and
each rail and each frame having a hole, the holes being aligned when each locking slot interlocked with one of the protruding tabs, the holes having a fastener preventing the protruding tabs from sliding within the slots.

10. The solar tracker assembly of claim 9, wherein each locking slot is open in a direction facing the support beam and open in a direction facing away from the support beam.

11. The solar tracker assembly of claim 9, wherein each locking slot is elongated in a direction non-parallel to the center axis of the support beam, thereby permitting the protruding tab to slide within the locking slot in the direction non-parallel center axis of the support beam.

12. The solar tracker assembly of claim 9, wherein each locking slot being a retention slot that retains the protruding tabs therein.

13. The solar tracker assembly of claim 9, wherein each protruding tab having a shoulder, the shoulder and a frame surface being on opposite faces of or straddling the slot when each when each locking slot is interlocked with one of the protruding tabs.

14. The solar tracker assembly of claim 9, wherein each protruding tab having an extension extending away from a frame surface and defining a central axis, and a shoulder that extends away from the extension central axis, the shoulder and the frame surface being on opposite faces of or straddling the slot and the extension extending through the slot when each locking slot is interlocked with one of the protruding tabs.

15. An assembly comprising:
a photovoltaic module having a glass laminate supported by an external metal frame, the metal frame having a pair of opposing long sides and a pair of opposing shorts sides collectively forming a rectangular frame, wherein each long side has a pair of pins projecting outward away from the frame, and terminating in a cap having an outer diameter greater than an outer diameter of the pin;
a pair of adjacent module rails attached to a single-axis tracker torque tube, wherein each module rail comprises a pair of slots on opposing sides of the torque tube, the slots substantially perpendicular to a main axis of the torque tube; wherein the pins of the module frame form a slot and pin mechanism to enable the photovoltaic module to move from an installation position to a seated position while the caps prevent lateral movement of the module within the slot in a direction of the main axis of the torque tube; and
at least one fastener passing through aligned holes of each rail and a corresponding one of the long sides of the rectangular frame proximate to one of the slots to secure the photovoltaic module in the seated position.

16. An assembly comprising:
a solar module frame comprising a coupling tab; and
a module support rail configured to couple to the solar module frame, the module support rail comprising a torque tube interface surface, a wall extending away from the torque tube interface surface, and a locking member that is movable relative to the wall, wherein the wall comprises a locking slot adjacent to the locking member, and wherein when the coupling tab is received at the locking slot, the locking member is configured to move relative to the wall to engage the coupling tab to thereby restrict movement of the solar module frame relative to the module support rail.

17. The assembly of claim 16, wherein, when the coupling tab is received at the locking slot, the locking member is movable relative to the wall between an unlocked position, at which the locking member is spaced apart from the coupling tab and offset from the locking slot, and a locked position, at which the locking member engages the coupling tab and is aligned with the locking slot.

18. The assembly of claim 17, wherein the locking slot is a first locking slot and the locking member is a first locking member, wherein the module support rail further comprises a second locking slot at the wall and spaced apart along the wall from the first locking slot, and wherein the module support rail further comprises a second locking member that is movable relative to the wall and adjacent to the second locking slot.

19. The assembly of claim 17, wherein the locking member comprises a hook element that pivots between the unlocked position and the locked position.

20. The assembly of claim 19, wherein the locking slot extends along the wall in a first direction generally transverse to the torque tube interface surface and in a second direction generally parallel to the torque tube interface surface, and wherein the extent of the locking slot in the first direction is greater than the extent of the locking slot in the second direction.
